(19) United States
(12) Patent Application Publication
(10) Pub. No.: US 2002/0176644 A1
(43) Pub. Date: Nov. 28, 2002

(54) Polarization combiner/splitter

(76) Inventors: Venkata A. Bhagavatula, Big Flats, NY (US); John Himmelreich JR., Horseheads, NY (US); Gaeyoun Kim, Irvine, CA (US); Kamjula P. Reddy, Corning, NY (US); Gregory E. Williams, Fayetteville, GA (US); Bryan J. Wolfe, Hammondsport, NY (US)

Correspondence Address: CORNING INCORPORATED, SP-TI-3-1, CORNING, NY, 14831

(21) Appl. No.: 10/099,651

(22) Filed: Mar. 14, 2002

Related U.S. Application Data
(60) Provisional application No. 60/276,808, filed on Mar. 16, 2001.

(51) Int. Cl. G02B 6/27

(52) U.S. Cl. 385/11

(57) ABSTRACT

The invention relates to a polarization combiner/splitter. The polarization combiner/splitter includes a first ferrule, a first optical fiber assembly coupled to the first ferrule and a second optical fiber assembly coupled to the first ferrule. The polarization combiner/splitter also includes a walk-off crystal coupled to the first ferrule. A second ferrule is coupled to the walk-off crystal; and a third optical fiber assembly coupled to the second ferrule. The first optical fiber assembly includes a first fiber GRIN lens coupled to a first polarization mode maintaining optical waveguide fiber. The second optical fiber assembly includes a second fiber GRIN lens coupled to a second polarization mode maintaining optical waveguide fiber. The third optical fiber assembly includes a third fiber GRIN lens and a first single mode optical waveguide fiber.

### CROSS-REFERENCE TO RELATED APPLICATIONS

This application claims the benefit of priority of U.S. Provisional Application Serial No. 60/276,808 filed on Mar. 16, 2001.

### BACKGROUND OF THE INVENTION

1. Field of the Invention

The present invention relates generally to combination and separation of optical signals and particularly to an optical device utilizing polarization to combine or separate optical signals.

2. Technical Background

With the introduction of high power amplifiers and in particular Raman amplifiers, the need for high power pumps increasing. One possible approach to increase the total pump power is to combine a number of pumps with lower powers. Since the output has to be coupled to a single-mode fiber, this can be accomplished by using pumps with different wavelengths and combining them with low loss WDM device. Another approach is to combine two pumps with orthogonal polarizations such as “s” and “p” linear polarizations using polarization combiners. There have been a number of proposals for polarization combiners. Some devices are based on either walk-off crystals with GRIN lens collimators or polrization beam spitting cubes. One of the disadvantages of using a walk-off crystal with a commercial GRIN lenses is the size of the crystal length needed due to the large diameter of the GRIN lenses. Another disadvantage is the cost and complexity of the GRIN collimator assembly. Some of the other approaches tried to address the issue of large crystal size required by using non-collimating GRIN lenses or complex imaging optics.

### SUMMARY OF THE INVENTION

One aspect of the invention is a polarization combiner/splitter. The polarization combiner/splitter includes a first ferrule. The polarization combiner/splitter includes further includes a first optical fiber assembly coupled to the first ferrule and a second optical fiber assembly coupled to the first ferrule. The polarization combiner/splitter also includes a walk-off crystal coupled to the first ferrule. A second ferrule is coupled to the walk-off crystal; and a third optical fiber assembly coupled to the second ferrule. The first optical fiber assembly includes a first fiber GRIN lens coupled to a first polarization mode maintaining optical waveguide fiber. The second optical fiber assembly includes a second fiber GRIN lens coupled to a second polarization mode maintaining optical waveguide fiber. The third optical fiber assembly includes a third fiber GRIN lens and a first single mode optical waveguide fiber.

In another embodiment, the present invention includes a method for making a polarization combiner/splitter. The method includes the steps of providing a first fiber GRIN lens and providing a first polarization mode maintaining fiber. The method further includes splicing the first fiber GRIN lens to the first polarization mode maintaining fiber, thereby forming a first optical assembly. The method further includes providing a second fiber GRIN lens and providing a second polarization mode maintaining fiber. The method further includes splicing the second fiber GRIN lens to the second polarization mode maintaining fiber, thereby forming a second optical assembly. The method includes providing a first ferrule, wherein the first ferrule includes two holes and inserting the first optical assembly into one of the two holes in the first ferrule. The method further includes inserting the second optical assembly into the other hole of the first ferrule and orienting the first and second optical assemblies so that the polarization modes maintained by the first and second polarization mode maintaining fibers are orthogonal to one another. The method further includes coupling the first and second optical assemblies to the first ferrule. The method further includes providing a third fiber GRIN lens and providing a single mode optical waveguide fiber. The method further includes splicing the third fiber GRIN lens to the single mode optical waveguide fiber, thereby forming a third optical assembly. The method further includes providing a single fiber ferrule, inserting the third optical assembly into the single fiber ferrule; and coupling the third optical assembly to the single fiber ferrule, thereby forming a second ferrule assembly. The method further includes providing a walk-off crystal. The method further includes aligning the optical axes of the first and third optical assemblies with one another, wherein the first and second ferrule assemblies are spaced apart one from another and positioning the walk-off crystal between the first and second ferrule assemblies. The method further includes orienting the walk-off crystal so that light emitted from the first optical assembly passes through the walk-off crystal without changing direction and so that light emitted from the second optical assembly is directed into the third optical assembly; and fixing the position of the first ferrule assembly, the walk-off crystal and the second ferrule assembly with respect to one another.

One advantage of the present invention is that it may be used to combine the output from multiple laser diodes for use in Raman amplifier applications.

Another advantage is that the present invention can be used to combine or split light of similar wavelengths that contains two linear and orthogonally polarized components.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operations of the invention.

### BRIEF DESCRIPTION OF THE DRAWINGS

FIG. 1 is a cross sectional view of one embodiment of the present invention;

FIG. 2 is a cross sectional view of the multi-fiber ferrule shown in FIG. 1.

### DETAILED DESCRIPTION OF THE PREFERRED EMBODIMENTS

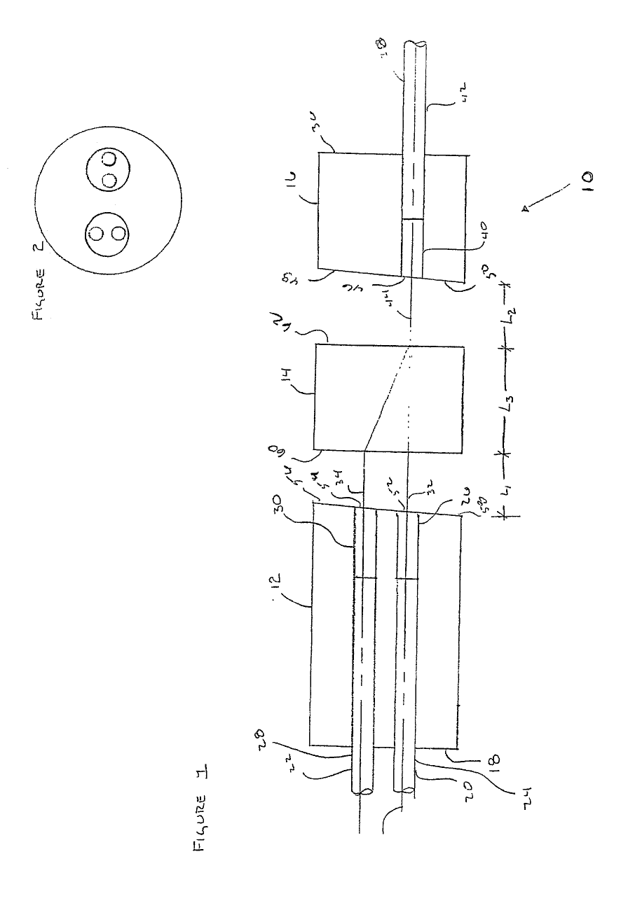

Reference will now be made in detail to the present preferred embodiments of the invention, examples of which are illustrated in the accompanying drawings. Whenever possible, the same reference numbers will be used throughout the drawings to refer to the same or like parts. An exemplary embodiment of the polarization combiner/splitter of the present invention is shown in FIG. 1, and is designated generally throughout by the reference numeral 10.

As embodied herein and depicted in FIG. 1, the polarization combiner/splitter 10 includes a first ferrule assembly 12, a walk-off crystal 14 and a second ferrule assembly 16.

The first ferrule assembly 12 includes a multiple fiber ferrule 18, such as, for example a two-fiber ferrule. The first ferrule assembly 12 also includes a first optical fiber assembly 20 and a second optical fiber assembly 22.

The multiple fiber ferrule 18 may be ceramic, glass or glass-ceramic. The multiple fiber ferrule 18 contains at least one, and preferably two holes. When the multiple fiber ferrule 18 contain two holes, the holes are preferably parallel to one another and a slightly larger than the diameter of the first and second optical fiber assemblies 20, 22. The multiple fiber ferrule 18 is used to precisely position the first and second optical fiber assemblies 20, 22 with respect to one another. The first and second optical fiber assemblies 20, 22 are coupled to the multiple fiber ferrule. The first and second optical fiber assemblies 20, 22 may be coupled to the multiple fiber ferrule 18 by an adhesive, such as, for example a thermal of photo curing adhesive, by locally melting a portion or portions of the multiple fiber ferrule 18 about the first and second optical fiber assemblies 20, 22 so as to couple the first and second optical fiber assemblies 20, 22 to the multiple fiber ferrule 18.

The first optical assembly 20 includes a first polarization mode maintaining fiber 24, such as, for example, a length of Panda® fiber, manufacture by Fujikura Ltd. of Japan and available from Corning Incorporated of Corning, N.Y., and a first fiber GRIN lens 26. The first fiber GRIN lens 26 is coupled to the first polarization mode maintaining fiber 24, such as, for example, by splicing. The first fiber GRIN lens 26 is a multimode optical waveguide fiber having a parabolic index of refraction profile. The diameter of the first fiber GRIN lens 26 is the same as the diameter of the first polarization mode maintaining fiber 24, such as, for example 125 μm.

The second optical assembly 22 includes a second polarization mode maintaining fiber 28, such as, for example, a length of Panda® fiber, manufacture by Fujikura Ltd. of Japan and available from Corning Incorporated of Corning, N.Y., and a second fiber GRIN lens 30. The second fiber GRIN lens 30 is coupled to the second polarization mode maintaining fiber 28, such as, for example, by splicing. The second fiber GRIN lens 30 is a multimode optical waveguide fiber having a parabolic index of refraction profile. The diameter of the second fiber GRIN lens 30 is the same as the diameter of the second polarization mode maintaining fiber 28, such as, for example 125 μm.

The first and second optical assemblies 20, 22 each have an optical axis 32, 34. The multiple fiber ferrule 18 positions the first and second optical assemblies 20, 22 with respect to one another. Because the diameters of the first and second fiber GRIN lenses 26, 30 are the same as the diameters of the first and second polarization mode maintaining fibers 22, 24 the first and second optical assemblies 20, 22 may be placed much closer to one another than in existing polarization beam combiners/splitters. For example, when the diameters of the first and second optical assemblies 20, 22 are 125 μm, the optical axes 32, 34 of the first and second optical assemblies 20, 22 may be positioned to within about 126 μm of one another. As will be detailed below, the spacing of the optical axes 32, 34 is important because it determines the length L₃ of the walk-off crystal 14.

The first and second optical assemblies 20, 22 are oriented so that the respective polarization states maintained by the first and second polarization mode maintaining fibers 24, 28 are orthogonal to one another.

In order, to reduce back reflection the faces 52, 54 of the first and second fiber GRIN lenses 26, 30 are angled with respect to the optical axes 32, 34 of the first and second optical assemblies 20, 22. The 52, 54 of the first and second fiber GRIN lenses for example, may be polished to form an angle of about 89° with the optical axes 32, 34 of the first and second optical assemblies 20, 22. Preferably, the faces 52, 54 of the first and second fiber GRIN lenses 26, 30 are parallel to one another.

In an alternative embodiment the first and second optical assemblies 20, 22 are coupled to the multiple fiber ferrule 18 so that the faces 52, 54 of the first and second fiber GRIN lenses 26, 30 and a surface 56 of the multiple fiber ferrule 18 may be polished to form a substantially planar surface 58 forming an angle of about 89° with the optical axes 32, 34 of the first and second optical assemblies 20, 22.

The first ferrule assembly 12 may be assembled by inserting the first and second optical assemblies 20, 22 into the multiple fiber ferrule 18. The polarization mode maintaining fibers 24, 28 are then illuminated and oriented so that the stress axes are orthogonal to one another as shown in FIG. 2.

The walk-off crystal 14 is a birefringent crystal and may, for example be made from yttrium vanadate, YVO₄. The walk-off crystal 14 includes two surfaces 60, 62 preferably the two surfaces 60, 62 are parallel to one another. The distance between the two surfaces 60, 62 is defined as the length L₃ of the walk-off crystal 14. When the light to be combined or split has a wavelength of about 1500 nm, the length of the walk-off crystal 14 is ten times the distance between the first and second optical assemblies 20, 22. For example, when the first and second optical assemblies 20, 22 are spaced 125 μm apart, the length L₃ of the walk-off crystal 14 is 1.25 mm. Typically, the length of the walk-off crystal 14 is between about 1.25 mm and 2.5 mm.

The walk-off crystal 14 is oriented with respect to the first and second optical assemblies 20, 22 so that linearly polarized light emitted from the first optical assembly 20 behaves as an ordinary ray of light, i.e., that is it travels in a straight line through the walk-off crystal 14, and linearly polarized light, which is orthogonally polarized with respect to the linearly polarized light emitted from the first optical assembly 20, emitted from the second optical fiber assembly 22 acts as an extraordinary ray.

The second ferrule assembly 16 includes a single fiber ferrule 36 and a third optical assembly 38. The third optical assembly 38 includes a third fiber GRIN lens 40 coupled to a single mode optical waveguide fiber, such as, for example a SMF-28® single mode optical waveguide fiber available from Corning Incorporated of Corning, N.Y. The optical axis 44 of the third optical assembly 40 is parallel with the optical axis 32 of the first optical assembly 20 and is offset by an amount determined by the angle of the faces 52, 54, 46 of the first, second and third fiber GRIN lenses 36, 30, 40 and the length L₃ of the walk-off crystal 14. In order, to reduce back reflection the face 46 of the third fiber GRIN lens 40 is angled with respect to the optical axis 44 of the third optical assembly 42. The face 46 of the third fiber GRIN lens for example, may be polished to form an angle of about 89° with the optical axis 44. In an alternative embodiment the third optical assembly 38 is coupled to the single fiber ferrule 36 so that the face 46 of the third fiber GRIN lens 46 and a surface 48 of the single fiber ferrule 36 may be polished to form a substantially planar surface 50 forming an angle of about 89° with the optical axis 44 of the third optical assembly 38.

Preferably, the faces 52, 54, 46 of the first, second and third fiber GRIN lenses 36, 30, 40 are parallel to one another.

The faces 52, 54 of the first and second fiber GRIN lenses 26, 30 are located at a distance L₁ from the surface 60 of the walk-off crystal 14. The face 46 of the third fiber GRIN lens 40 is located at a distance L₂ from the surface 62 of the walk-off crystal 14. The distances L₁, L₂ are small and typically on the order of a few microns to a few hundred microns. A gap of about 100 μm to about 200 μm has been used.

The first, second and third fiber GRIN lenses 26, 30, 40 are designed for optimal coupling efficiency for the optical gap in the design. The optical gap is slightly larger than the length L₃ of the walk-off crystal 14. The first, second and third fiber GRIN lenses 26, 30, 40 are designed to have beam waist at half the optimal distance of the gap. The optical gap is given by:

$$Optical Gap = \frac{{L}_{1}}{{n}_{air}} + \frac{{L}_{2}}{{n}_{air}} + \frac{{L}_{3}}{{n}_{crystal}} \qquad ( 1 )$$

where—

L₁, L₂ and L₃ are as defined above;

nₐᵢᵣ is the index of refraction of air (nₐᵢᵣ-1); and

n_{crystal} is the index of refraction of the walk-off crystal.

It will be apparent to those skilled in the optical arts that other materials, such as, example adhesives, oils, or gels may be used to fill the regions between the first, second and third fiber GRIN lenses 26, 30, 40 and the surfaces 60, 62 of the walk-off crystal 14 and that the index of refraction of such a material must be substituted in equation (1) for nₐᵢᵣ.

The first, second and third fiber GRIN lenses 26, 30, 40 typically have a Δ of 1%, a core diameter of 125 μm and a length of 700 μm.

In another embodiment, the present invention includes a method for making a polarization combiner/splitter, such as that shown in FIG. 1.

The method includes the steps of providing a first fiber GRIN lens and providing a first polarization mode maintaining fiber.

The method further includes coupling the first fiber GRIN lens to the first polarization mode maintaining fiber to form a first optical assembly. The first fiber GRIN lens may, for example, be coupled to the first polarization mode maintaining fiber by fusion splicing, laser splicing or adhesive bonding.

The method further includes the steps of providing a second fiber GRIN lens and providing a second polarization mode maintaining fiber.

The method further includes splicing the second fiber GRIN lens to the second polarization mode maintaining fiber, thereby forming a second optical assembly. The second fiber GRIN lens may, for example, be coupled to the second polarization mode maintaining fiber by fusion splicing, laser splicing or adhesive bonding.

The method includes the steps of providing a first ferrule, wherein the first ferrule includes two longitudinal holes and inserting the first optical assembly into one of the two holes in the first ferrule. The ferrule may be, for example, a glass ferrule.

The method further includes the step of inserting the second optical assembly into the other hole of the first ferrule and then orienting the first and second optical assemblies so that the polarization modes maintained by the first and second polarization mode maintaining fibers are orthogonal to one another.

The method further includes coupling the first and second optical assemblies to the first ferrule to form a first ferrule assembly. The first and second optical assemblies may be coupled to the first ferrule by adhesive bonding.

The method further includes providing a third fiber GRIN lens and providing a single mode optical waveguide fiber. The method further includes coupling the third fiber GRIN lens to the single mode optical waveguide fiber, thereby forming a third optical assembly. The third fiber GRIN lens may, for example, be coupled to the s single mode optical waveguide fiber by fusion splicing, laser splicing or adhesive bonding.

The method further includes the steps of providing a single fiber ferrule, inserting the third optical assembly into the single fiber ferrule; and coupling the third optical assembly to the single fiber ferrule, thereby forming a second ferrule assembly.

The method further includes providing a walk-off crystal, such as, for example a birefringent crystal made from yttrium vanadate, YVO₄.

The method further includes the step of aligning the optical axes of the first and third optical assemblies with one another. The first and second ferrule assemblies are spaced apart one from another and the walk-off crystal is positioned between the first and second ferrule assemblies.

The method further includes the step of orienting the walk-off crystal so that light emitted from the first optical assembly passes through the walk-off crystal without changing direction and so that light emitted from the second optical assembly is directed into the third optical assembly. The method further includes the step of fixing the position of the first ferrule assembly, the walk-off crystal and the second ferrule assembly with respect to one another.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An polarization combiner/splitter comprising:
a first fiber alignment structure;
a first optical fiber assembly coupled to said first fiber alignment structure;
a second optical fiber assembly coupled to said first fiber alignment structure;
a walk-off crystal coupled to said first fiber alignment structure;
a second fiber alignment structure coupled to said walk-off crystal; and
a third optical fiber assembly coupled to said second fiber alignment structure;
wherein said first optical fiber assembly includes a first fiber GRIN lens coupled to a first polarization mode maintaining optical waveguide fiber;
wherein said second optical fiber assembly includes a second fiber GRIN lens coupled to a second polarization mode maintaining optical waveguide fiber; and
wherein said third optical fiber assembly includes a third fiber GRIN lens and a first single mode optical waveguide fiber.

2. The polarization combiner/splitter of claim 1 wherein said walk-off crystal includes a first surface and a second surface, wherein said first surface is substantially parallel to said second surface.

3. The polarization combiner/splitter of claim 2 wherein said first fiber GRIN lens is disposed proximate to said first surface of said walk-off crystal; wherein said second fiber GRIN lens is disposed proximate to said first surface of said walk-off crystal and wherein said third fiber GRIN lens is disposed proximate to said second surface of said walk-off crystal.

4. The polarization combiner/splitter of claim 1 wherein said walk-off crystal comprises a birefringent crystal.

5. The polarization combiner/splitter of claim 4 wherein said birefringent comprises a YVO₄ crystal.

6. The polarization combiner/splitter of claim 1 wherein said first and second optical fiber assemblies each include an optical axis and said optical axes are substantially parallel one to another.

7. A method for making an polarization combiner/splitter comprising the steps of:
providing a first GRIN fiber;
providing a first polarization mode maintaining fiber;
splicing the first GRIN fiber to the first polarization mode maintaining fiber, thereby forming a first optical assembly;
forming a first GRIN lens;
providing a second GRIN fiber;
providing a second polarization mode maintaining fiber;
splicing the second GRIN fiber to the second polarization mode maintaining fiber, thereby forming a second optical assembly;
forming a second GRIN lens;
providing a first fiber alignment structure, wherein the first fiber alignment structure includes two holes;
inserting the first optical assembly into one of the two holes in the first fiber alignment structure;
inserting the second optical assembly into the other hole of the first fiber alignment structure;
orienting the first and second optical assemblies so that the polarization modes maintained by the first and second polarization mode maintaining fibers are orthogonal to one another;
coupling the first and second optical assemblies to the first fiber alignment structure;
providing a third GRIN fiber;
providing a single mode optical waveguide fiber;
inserting the third optical assembly into the single fiber alignment structure;
coupling the third optical assembly to the single fiber alignment structure, thereby forming a second fiber alignment structure assembly;
providing a walk-off crystal;
aligning the optical axes of the first and third optical assemblies with one another, wherein the first and second fiber alignment structure assemblies are spaced apart one from another;
positioning the walk-off crystal between the first and second fiber alignment structure assemblies;
orienting the walk-off crystal so that light emitted from the first optical assembly passes through the walk-off crystal without changing direction and so that light emitted from the second optical assembly is directed into the third optical assembly; and
fixing the position of the first fiber alignment structure assembly, the walk-off crystal and the second fiber alignment structure assembly with respect to one another.
